(19) United States
(12) Patent Application Publication
(10) Pub. No.: US 2014/0167983 A1
(43) Pub. Date: Jun. 19, 2014

(54) INTEGRATION OF VEHICLE WITH HOME-CENTRIC SYSTEM

(71) Applicant: Zubie, Inc., Bloomington, MN (US)

(72) Inventors: Michael John Rude, Excelsior, MN (US); Ari Abram Silkey, Burnsville, MN (US)

(73) Assignee: Zubie, Inc., Bloomington, MN (US)

(21) Appl. No.: 14/105,816

(22) Filed: Dec. 13, 2013

Related U.S. Application Data
(60) Provisional application No. 61/737,298, filed on Dec. 14, 2012.

(51) Int. Cl. G08C 17/02

(52) U.S. Cl. CPC G08C 17/02
USPC 340/870.07

(57) ABSTRACT

One embodiment is directed to a method for integrating vehicle-centric information with home-centric information. The method includes wirelessly transmitting a signal from a vehicle information device within a vehicle to a component of a home-centric system and receiving the signal at the component from the vehicle information device. The method also includes sending vehicle-centric information from the component to a command center for the home-centric system based on the signal received from the vehicle information device, and integrating the vehicle-centric information with home-centric information obtained by the home-centric system. The method also includes displaying information based on the vehicle-centric information along with the home centric information at an interface for a user.

### CROSS-REFERENCE TO RELATED APPLICATIONS

This application claims the benefit of U.S. Provisional Patent Application Ser. No. 61/737,298, filed on Dec. 14, 2012, which is hereby incorporated herein by reference.

### BACKGROUND

Many different home-centric systems exist, such as home security systems, home smart appliance networks, home smart energy systems, and others. These home-centric systems can include sensors or components that are physically located at different places throughout the home and are in communication with a central “command center” that consolidates information from each of the sensor/components and may perform appropriate action based thereon. The information obtained (e.g., sensed, generated) by such a home-centric system is referred to herein as “home-centric information”. Home-centric information can include any information obtained by the home-centric system that is specific to the user's premises (e.g., land and buildings) in which the home-centric system is physically located. In examples where the home-centric system is a home-security system, the home-centric information can include whether a particular entry door, window, or garage door is opened, or whether a motion sensor has sensed any motion. In examples where the home-centric system is a home automation system, the home-centric information can include whether or not a particular light or set of lights is off/on, a current temperature of the house, or information obtained from an appliance of the house. In examples where the home-centric system is a home smart energy system, the home-centric information can include the energy being consumed by all devices of a premises, energy being consumed by one or more particular devices, or energy generated by a renewable source (e.g., a solar panel).

As mentioned above, a home-centric system typically includes a “command center” that communicates with and controls the sensors/components of the home-centric system and consolidates home-centric information obtained by such sensors/components. The command center can provide access to such home-centric information for a user and/or can perform appropriate automated action based on the home-centric information. For example, a home security system usually includes a command center computer system that is communicatively coupled to various sensors (e.g., door/window open sensors, motion sensors) throughout the house as well as one or more user input/output devices (e.g., keypads). The command center computer system is typically in communication with a central office of a security provider via a phone line or the Internet. The communication with the command center can be used to alert the central office of any security breaches of the home in response to which the central office can contact the appropriate authorities. The subscribers to the security system may be able to interact with the command center in one or more ways. This includes localized interaction, for example, via the in-home input/output devices (e.g., keypads) or via local network connection to the command center from a computing device (e.g., computer, tablet). The subscribers may also be able to interact with the command center via a web-based interface. In such an example, a server hosted by the security provider can be in communication with the command center and/or central office and can provide a portal, viewable via a web browser, through which a subscriber can access their security system to view status and potentially update settings from a device connected to the Internet (web).

Other home-centric systems include a similar “command center” having connectivity to devices/components through the home as well as communication to one or more remote devices/servers via the Internet and/or a phone line. Such other home-centric systems can also provide subscriber interaction locally (e.g., keypad, local-network connected computing device) and/or via the web (e.g., through a web-browser on a device connected to the Internet).

### SUMMARY

One embodiment is directed to a method for integrating vehicle-centric information with home-centric information. The method includes wirelessly transmitting a signal from a vehicle information device within a vehicle to a component of a home-centric system and receiving the signal at the component from the vehicle information device. The method also includes sending vehicle-centric information from the component to a command center for the home-centric system based on the signal received from the vehicle information device, and integrating the vehicle-centric information with home-centric information obtained by the home-centric system. The method also includes displaying information based on the vehicle-centric information along with the home centric information at an interface for a user.

### DRAWINGS

FIG. 1 is a block diagram of an example of a system including a vehicle information device and a home-centric system.

FIG. 2 is a block diagram of an example vehicle including a vehicle information device for use in the system of FIG. 1.

FIG. 3 is a block diagram of an example vehicle information device for use in the system of FIG. 1 and the vehicle of FIG. 2.

### DETAILED DESCRIPTION

The subject matter described herein pertains to integration of information regarding a vehicle with home-centric information obtained by a home-centric system. As used herein information regarding a vehicle is referred to as “vehicle-centric information”. One or more sensors and/or communication devices can be physically attached to the vehicle and such sensor and/or communication device can be used to obtain vehicle-centric information that can be integrated with the home-centric information. The integration of the vehicle-centric information with the home-centric information can enable an end-user (e.g., subscriber) to view/edit the vehicle-centric information in the same user interface (e.g., web portal) as used to view/edit the home-centric information. Moreover, synergistic benefits may be achieved when a single system has both the vehicle-centric information and the home-centric information.

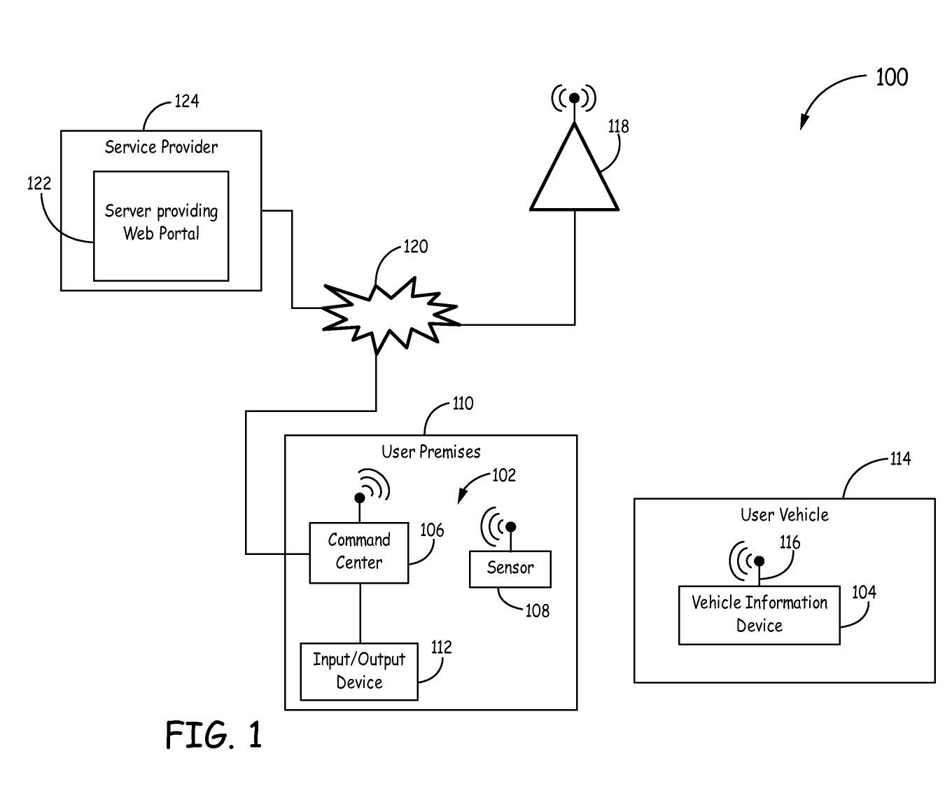

FIG. 1 is a block diagram of an example system 100 including a home-centric system 102 and a vehicle information device 104. The home-centric system 102 can include a command center 106 physically located at a user's premises 110. The home-centric system 102 can also include one or more sensors/components 108 and, optionally, one or more input/output devices 112, which are communicatively coupled to the command center 106 and also physically located at the user's premises 110. In an example, the sensors/components 108 and input/output devices 112 are communicatively coupled to the command center 106 via private and local (e.g., non-Internet based) means, such as wires routed about the user's premises 110 or short range wireless communication. Such private and local communication can occur via any suitable communication medium including wired or wireless mediums. Being physically located at the user's premises 110 includes being located within a building on a user's real estate property, attached to an exterior of such building, or otherwise located at the user's real estate property. The home-centric system 102 can obtain home-centric information as discussed above. In an example a building on a user's property includes a place of residence (e.g., house), an office building, a workshop, a garage, a shed, as well as other buildings. Home-centric information can include any information obtained by a home-centric system as discussed in the background above.

The vehicle information device 104 is physically attached to a user's vehicle 114. The vehicle information device 104 is used to obtain information regarding the vehicle 114 (vehicle-centric information) that can be integrated with the home-centric information obtained by the home-centric system 102. The vehicle information device 104 includes an antenna 116 for transmitting, and optionally receiving, wireless signals.

In some examples, the vehicle information device 104 is used in a passive manner, wherein the vehicle information device 104 periodically transmits a beacon signal, and vehicle-centric information is generated by a sensor 108 of the home-centric system 102 in response to receiving the beacon signal. Such vehicle-centric information generated by the sensor 108 can then be integrated with the home-centric information by providing the vehicle-centric information from the sensor 108 that generated the vehicle-centric information to the command center 106. In other examples, the vehicle information device 104 is used in an active manner, wherein the vehicle information device 104 generates vehicle-centric information and transmits the vehicle-centric information to an appropriate device such that the vehicle-centric information can be integrated with home-centric information obtained by the home-centric system 102.

Integrating the vehicle-centric information with the home-centric information can include providing access for a user to both the home-centric information and the vehicle-centric information within the same interface. For example, the vehicle-centric information and the home-centric information can both be accessed at a local interface, such as a display device at the user's premises 110 that is in communication with the command center 106. In such an example, the vehicle-centric information is provided to the command center 106 (e.g., via a sensor/component 108 or via the cellular tower 118 and public network 120) such that the command center 106 can provide the vehicle-centric information at the local interface along with the home-centric information. In another example, the interface is a web-portal. In an implementation of such an example, the web-portal is hosted by a service provider 124 and the home-centric information as well as the vehicle-centric information are provided to a server 122 hosting the web-portal. The home-centric information and the vehicle-centric information are provided via the public network 120 to the server 122 providing the web-portal.

In one example, the vehicle information device 104 is used in conjunction with a sensor/component 108 of the home-centric system 102 to function as a proximity sensor and obtain vehicle-centric information corresponding to whether or not the vehicle 114 is present at the user's premises 110. In one implementation of such an example, the vehicle-centric information can include whether or not the vehicle 114 is in a garage at the user's premises 110.

Such a proximity sensor can be achieved by in several ways. One implementation includes having the vehicle information device 104 periodically send out a beacon which can be received by the sensor/component 108 of the home-centric system 102. In such an implementation, the sensor/component 108 can report vehicle-centric information to the command center 106 based on whether or not the beacon from the vehicle information device 104 has been received. In an alternative implementation, the sensor/component 108 can periodically send out a beacon which can be received by the vehicle information device 104. In such an alternative implementation, the vehicle information device 104 can report vehicle-centric information corresponding to whether or not the beacon has been received. The vehicle information device 104 can report such vehicle-centric information to the appropriate device such that the vehicle-centric information can be integrated with the home-centric information. For example, the vehicle information device 104 can send the vehicle-centric information to the sensor/component 108 that sent out the beacon or to another sensor/component 108 of the home-centric system 102. Such a sensor/component 108 receiving the vehicle-centric information can relay the vehicle-centric information on to the command center 106 for integration with the home-centric information. As an example, the other sensor/component 108 that communicates with the vehicle information device 104 to receive the vehicle-centric information therefrom can include a proprietary wireless receiver for the home-centric system 102 or a general purpose access point (e.g., compliant with IEEE 802.11) for a local area network at the user's premises 110, wherein the command center 106 is coupled to the local area network and in communication with the general purpose access point. Alternatively, the vehicle information device 104 can send the vehicle-centric information over a public network 120, such as the Internet, via communication with a wireless communication node 118 (e.g., a cellular communication tower) to the command center 106.

In any case, the vehicle-centric information regarding whether the vehicle 114 is at the user's premises 110 can be integrated with the home-centric system 102 such that a user can obtain the vehicle-centric information though the same interface as information specific to the home-centric system 102. For example, a web-portal for a home-security system (home-centric system 102) can display its specific information (such as whether all doors and windows have remained closed) and can also display whether the vehicle 114 is within the garage and whether the garage door is closed. Thus, a user can be assured that their vehicle 114 is still in the garage while they are away from home.

Integrating the vehicle-centric information with the home-centric information can also include taking an action based on both the home-centric information and the vehicle-centric information. For example, a notification can be generated if a certain set of characteristics including both home-centric information and vehicle-centric information occurs. Such a notification can be generated by the home-centric system 102 in examples where the integration of vehicle-centric information and home-centric information occurs at the command center 106 of the home-centric system 102. Such a notification can also be generated by a remote server (e.g., the server 122) in examples where the integration of vehicle-centric information and home-centric information occurs at the remote server.

In the proximity sensor example discussed above, a home-centric system 102 can be configured to perform certain actions based on whether or not the vehicle 114 is at the user's premises 110 (e.g., within a garage). For example, a home-security system (home-centric system 102) can be configured to notify its central office (and therefore the appropriate authorities) if the vehicle 114 is moved away from the user's premises 110 while the home-security system is armed. In this way, authorities can be notified if an attempted theft of a vehicle 114 from a user's premises 110 is attempted.

Another example of vehicle-centric information that can be obtained and integrated with the home-centric information includes information regarding whether the vehicle is currently running. This vehicle-centric information can be made available to a user through an interface along with home-centric information, such as whether a garage door is closed. Moreover, a notification can be sent to the user if the vehicle is running and the garage door is closed, or has been closed for a defined period of time.

Another example of vehicle-centric information that can be obtained and integrated with the home-centric information includes information regarding the charging of a plug-in electric car (vehicle 114). Such information can include whether the vehicle 114 is charging, how much energy it is drawing, and/or how close to fully charged (e.g., as a percentage) the car is. In one implementation, this vehicle-centric information can be integrated with home-centric information from a home smart energy system (home-centric system 102). Such a home smart energy system can use the integration of this information to determine when or how much energy to provide to the car. Other uses are also possible.

Another example of vehicle-centric information that can be obtained and integrated with the home-centric information includes any information available to the computer system of the car, such as but not limited to, fuel level, odometer reading, engine temperature, diagnostic codes, etc.

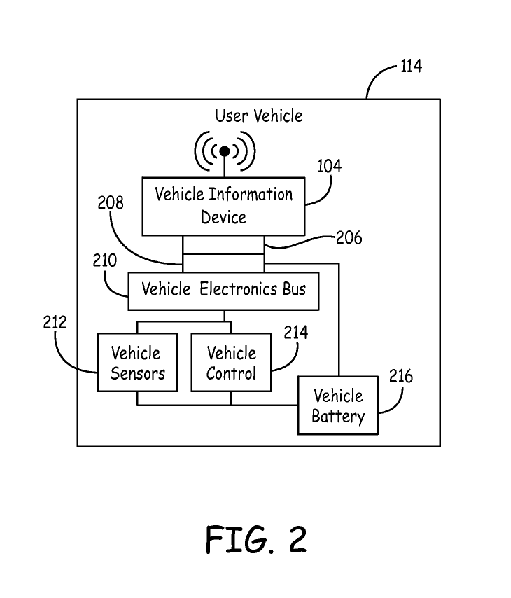

FIG. 2 is a block diagram of an example vehicle 114 including an example vehicle information device 104. In this example, the vehicle information device 104 is an aftermarket device that is coupled to the vehicle electronics bus 210 through an on-board diagnostics (OBD) port of the vehicle 114. The vehicle information device 104 includes an OBD connector 206 configured to connect to a mating OBD connector 208 on the vehicle 114. The OBD connector 208 on the vehicle 114 is coupled to a vehicle electronics bus 210 over which vehicle sensors 212, vehicle control electronics 214, and other electronics in the vehicle 114 communicate. The vehicle sensors 212 and the vehicle control electronics 214 receive power from a battery 216 in the vehicle 114. As known, this battery 216 can also be the battery that provides power for starting and/or driving the vehicle 114. The battery 216 can also be coupled to a plurality of conductors on the OBD connector 208 of the vehicle 114. These conductors can contact corresponding power conductors on the OBD connector 206 of the vehicle information device 104. In this way, the vehicle information device 104 can obtain operating power from the battery 216 of the vehicle 114 through the OBD connectors 206, 208. Example OBD connectors 206, 208, include the SAE-J1962 connector, which is the connector for the OBD-II protocol described in the SAE-J1978 standard. The vehicle 114 can include any automobile having an OBD connector 208 including, but not limited to, a car, pick-up, SUV, bus, semi-truck, construction vehicle, or motorcycle.

Although the example of the vehicle information device 104 shown in FIG. 2 and described above is an aftermarket device, in other examples, the vehicle information device 104 is a device that is integrated into the vehicle 114 (e.g., by the vehicle manufacturer). In such an example, the vehicle information device 104 is coupled to the vehicle electronics bus 210 that functions in a similar manner to that described above.

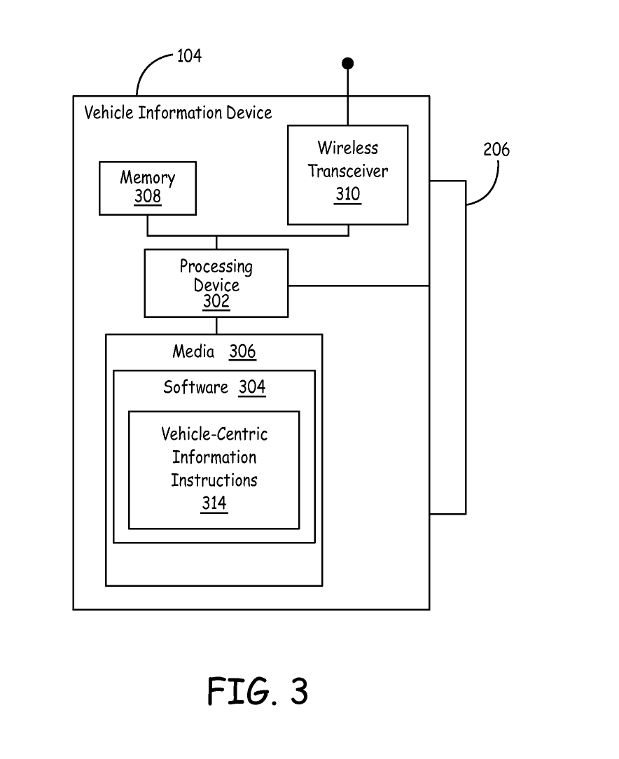

FIG. 3 is a block diagram of an example vehicle information device 104. The vehicle information device 104 can include one or more processing devices 302 for executing instructions 304. The one or more processing devices 302 can include a general purpose processor or a special purpose processor. The instructions 304 are stored (or otherwise embodied) on or in an appropriate storage medium or media 306 (such as flash or other non-volatile memory) from which the instructions 304 are readable by the processing device(s) 302 for execution thereby. The vehicle information device 104 also includes memory 308 that is coupled to the processing device(s) 302 for storing instructions (and related data) during execution by the processing device(s) 302. Memory 308 comprises, in one implementation, any suitable form of random access memory (RAM) now known or later developed, such as dynamic random access memory (DRAM). In other implementations, other types of memory are used. The vehicle information device 104 also includes the OBD connector 206 discussed above.

The vehicle information device 104 also includes a wireless transceiver 310 for wireless communicatively with other devices. In some examples, the wireless transceiver 310 is configured to couple the vehicle information device 104 to the cellular tower 118. In some examples, the wireless transceiver 310 is configured to couple the vehicle information device 104 to a sensor/component 108 of the home-centric system 102. In some examples, the wireless transceiver 310 is configured to send and/or receive a beacon signal for implementing a proximity detector as discussed above with respect to FIG. 1. In some examples, more than one wireless transceiver 310 can be used to accomplish multiple of the above functions and/or a single wireless transceiver 310 can be configured to accomplish multiple of the above functions. The wireless communications between the wireless transceiver 310 and other devices can conform to any suitable protocol. For example, wireless communications between the wireless transceiver 310 and the sensor/component 108 can use IEEE 802.11 (WiFi), IEEE 802.14.5 (ZigBee), Bluetooth, a proprietary protocol, or other protocol. Wireless communications between the wireless transceiver 310 and the cellular tower 118 can use a 2G (e.g., GPRS), 2.5G, 3G or 4G (e.g., WiMax, LTE) protocol or any future protocol.

The instructions 204 on the vehicle information device 104 include vehicle-centric information instructions 314 that are configured to cause the processing device(s) 302 to implement the functions of the vehicle information device 104 described herein; in particular to implement the functions to passively or actively interact with the home-centric system 102 such that vehicle-centric information can be obtained and integrated with home-centric information as described above.

Referring back to FIG. 1, in examples where the vehicle information device 104 is an aftermarket device, the vehicle information device 104 may be obtained by the user via a provider of the home-centric system 102 or via a retail outlet not associated with the home-centric system 102. Once obtained, the user can install the vehicle information device 104 by connecting the OBD connector 206 of the vehicle information device 104 to the OBD connector 208 of the vehicle 114. Upon connecting with the OBD connector 208 of the vehicle 114, the vehicle information device 104 can initiate operation.

In some examples the vehicle information device 104 can be provisioned for operation by the service provider for the home-centric system 102. Provisioning can include providing identification information (e.g., a serial number) for the vehicle information device 104 to such a service provider such that the service provider can associate the particular vehicle information device 104 with the user's account for the home-centric system 102.

In some examples, the vehicle information device 104 can have other purposes and functionality, such as obtaining vehicle operation information for the vehicle 114 over the OBD connectors 206, 208 form the vehicle electronics bus 210, and providing such vehicle operation information (e.g., via wireless communication with a cellular tower 118) to a third party for analysis, such as for us with usage based insurance. Other uses are also possible.

What is claimed is:

1. A method for integrating vehicle-centric information with home-centric information, the method comprising:
wirelessly transmitting a signal from a vehicle information device within a vehicle to a component of a home-centric system;
receiving the signal at the component from the vehicle information device;
sending vehicle-centric information from the component to a command center for the home-centric system based on the signal received from the vehicle information device;
integrating the vehicle-centric information with home-centric information obtained by the home-centric system; and
displaying information based on the vehicle-centric information along with the home centric information at an interface for a user.

2. The method of claim 1, wherein wirelessly transmitting a signal includes wirelessly transmitting a beacon signal; the method further comprising:
generating the vehicle-centric information at the component in response to receiving the beacon signal, wherein the vehicle-centric information includes information identifying the beacon signal and indicating that the beacon signal is being received.

3. The method of claim 2, comprising:
receiving the vehicle-centric information at the command center from the component; and
determining the vehicle to which the beacon signal corresponds,
wherein displaying the vehicle-centric information includes displaying information identifying the vehicle and indicating that the vehicle is within wireless communication range of the home-centric system.

4. The method of claim 1, comprising:
obtaining, by the vehicle information device, at least some of the vehicle-centric information from one or more components coupled to an electronics bus of the vehicle, wherein wirelessly transmitting a signal from a vehicle information device includes wirelessly transmitting a signal including the vehicle-centric information, the vehicle-centric information including information identifying at least one of the vehicle information device and the vehicle.

5. The method of claim 1, wherein the at least some of the vehicle-centric information includes at least one of: information regarding whether the vehicle is presently running, information regarding charging of a battery of the vehicle, information regarding a odometer reading of the vehicle, information regarding a fuel level of the vehicle, information regarding engine temperature of the vehicle, and information regarding diagnostic codes for the vehicle.

6. The method of claim 1, wherein the information displayed based on the vehicle-centric information indicates that the vehicle is presently located within a garage associated with the component of the home-centric system.

7. The method of claim 1, wherein displaying information includes causing information to be displayed through a web-portal accessible over at least one of a local network to which the command center is coupled and the Internet.

8. The method of claim 1, wherein integrating the vehicle-centric information with home-centric information includes determining whether an action is to be taken based on both the vehicle-centric information and the home-centric information.

9. The method of claim 8, wherein the home-centric system is a home security system and the vehicle-centric information indicates whether the vehicle is presently located within a garage associated with the component of the home-centric system,
wherein determining whether an action is to be taken based on both the vehicle-centric information and the home-centric information includes:
determining whether the vehicle is presently within the garage based on the vehicle-centric information and whether a door of the garage has been opened based on the home-centric information; and
generating an alert indicating that the vehicle may have been removed from the garage if, while the home-security system is armed, the state of the vehicle is determined to have changed from present to not present and the door of the garage has been opened.

10. A system for integrating vehicle-centric information with home-centric information, the system comprising:
a home-centric system including a command center and at least one component located remotely from and coupled to the command center;
a vehicle information device disposed within a vehicle and coupled to an electronics bus of the vehicle, the vehicle information device configured to wirelessly transmit a signal that can be received by the component of the home-centric system;
wherein the component of the home-centric system is configured to send vehicle-centric information based on the signal received from the vehicle information device to the command center;
wherein the command center is configured to integrate the vehicle-centric information with the home-centric information; and
wherein display information based on the vehicle-centric information along with the home centric information at an interface for a user.

11. The system of claim 10, wherein the vehicle information device is coupled to the electronics bus of the vehicle through an on-board diagnostics (OBD) port, wherein the vehicle information device includes:
a connector configured to connect to an OBD port of the vehicle and to obtain at least some of the vehicle-centric information from one or more vehicle components communicatively coupled to the OBD port;
wherein the signal from the vehicle information device includes the at least some of the vehicle-centric information.

12. The system of claim 11, wherein the at least some of the vehicle centric information includes at least one of: information regarding whether the vehicle is presently running, information regarding charging of a battery of the vehicle, information regarding a odometer reading of the vehicle, information regarding a fuel level of the vehicle, information regarding engine temperature of the vehicle, and information regarding diagnostic codes for the vehicle.

13. The system of claim 10, wherein the vehicle information device is integrated into the vehicle and is configured to obtain at least some of the vehicle-centric information from one or more vehicle components communicatively coupled to the OBD port;
wherein the signal from the vehicle information device includes the at least some of the vehicle-centric information.

14. The system of claim 10, wherein the home-centric system includes one of a home security system, a home smart energy system, and a home smart appliance network.

15. The system of claim 10, wherein wirelessly transmitting a signal includes wirelessly transmitting a beacon signal;
wherein the home-centric system is configured to generate the vehicle-centric information at the component in response to receiving the beacon signal, wherein the vehicle-centric information includes information identifying the beacon signal and indicating that the beacon signal is being received.

16. The system of claim 15, wherein the command center is configured to:
receive the vehicle-centric information from the component; and
determining the vehicle to which the beacon signal corresponds,
wherein display the vehicle-centric information includes display information identifying the vehicle and indicating that the vehicle is within wireless communication range of the home-centric system.

17. The system of claim 10, wherein integrate the vehicle-centric information with home-centric information includes determine whether an action is to be taken based on both the vehicle-centric information and the home-centric information.

18. The system of claim 17, wherein the home-centric system is a home security system and the vehicle-centric information indicates whether the vehicle is presently located within a garage associated with the component of the home-centric system,
wherein determine whether an action is to be taken based on both the vehicle-centric information and the home-centric information includes:
determine whether the vehicle is presently within the garage based on the vehicle-centric information and whether a door of the garage has been opened based on the home-centric information; and
generate an alert indicating that the vehicle may have been removed from the garage if, while the home-security system is armed, the state of the vehicle is determined to have changed from present to not present and the door of the garage has been opened.

19. An electronic device comprising:
a connector configured to connect to an on-board diagnostics (OBD) port of a vehicle;
a wireless transceiver configured to communicate with a home-centric system;
one or more processing devices coupled to the connector and to the wireless transceiver;
one or more data storage mediums coupled to the one or more processing devices and including instructions which, when executed by the one or more processing devices, cause the one or more processing devices to:
obtain vehicle-centric information from one or more components of the vehicle through the OBD port; and
send a signal to the home-centric system including the vehicle-centric information.

20. The electronic device of claim 19, wherein the vehicle centric information includes at least one of: information regarding whether the vehicle is presently running, information regarding charging of a battery of the vehicle, information regarding a odometer reading of the vehicle, information regarding a fuel level of the vehicle, information regarding engine temperature of the vehicle, and information regarding diagnostic codes for the vehicle.
